(19) United States
(12) Patent Application Publication
(10) Pub. No.: US 2018/0355226 A1
(43) Pub. Date: Dec. 13, 2018

(54) SCRIMLESS SURFACE COVERING

(71) Applicant: CHILEWICH SULTAN, LLC, New York, NY (US)

(72) Inventor: Joseph SULTAN, New York, NY (US)

(21) Appl. No.: 15/619,050

(22) Filed: Jun. 9, 2017

(51) Int. Cl. C09J 103/02; C09J 5/02; C09J 5/06; B32B 37/12; B32B 37/06

(52) U.S. Cl. CPC C09J 103/02; C09J 5/02; C09J 5/06; B32B 2607/00; B32B 37/06; C09J 2403/00; B32B 37/12

(57) ABSTRACT

A surface covering system includes a scrimless woven textile surface covering and an adhesive composition. The adhesive composition includes a dextrin and a polymer and does not migrate down a wall while setting. The adhesive composition forms enough points of contact with the textile that the textile can be installed on and remain installed on a wall. Upon removal of the covering, the adhesive composition adheres to the wall and little or no covering remains adhered to the composition.

### FIELD

The present disclosure relates to adhesive compositions for use with textile surface coverings and without a scrim, systems of scrimless textile surface coverings, and methods of making and using the same.

### BACKGROUND

Textiles may be secured to walls and floors using adhesives. Known adhesives often bleed into or through the pores of woven textiles. The amount of bleed-through can be great enough that the adhesive overlays some or all of the visible surface of the textile.

A backing or scrim, such as of nylon or paper, helps prevent bleed-through and provides a smooth, large, contiguous surface to which the adhesive can be applied. The scrim also helps the adhesive remain in place on vertical surfaces while the adhesive is setting or curing. When the textile is later removed, small particles of the scrim are left behind on the surface along with some or all of the adhesive. Removing the particles and preparing the surface for application of a new aesthetic finish is very difficult, time-consuming, and can negatively impact the appearance of the subsequently applied finish.

In some instances, adhesives are used that remain affixed to the scrim when the textile is removed. Particles of the surface are removed along with the textile. The surface must be repaired or replaced before application of a new aesthetic finish, which increases costs and is time-consuming.

The information included in this Background section of the specification, including any references cited herein and any description or discussion thereof, is included for technical reference purposes only and is not to be regarded as subject matter by which the scope of the invention as defined in the claims is to be bound.

### SUMMARY

The technology disclosed herein relates to adhesive compositions for textile surface coverings. The adhesive compositions may be used in the absence of a scrim. The adhesive compositions may set or cure.

In one example, a system for covering an installation surface includes a vinyl, scrimless textile and a settable adhesive composition. The set adhesive composition is hard enough to sand and adheres less to the textile than to the installation surface. The textile is strippable from the set composition.

In some examples, the adhesive composition remains affixed to the surface but not to the covering when the covering is removed from the surface.

In some examples, the adhesive composition has an average shear strength high enough that the affixed textile is held in place on the surface.

In some examples, the adhesive composition has an average shear strength high enough that the affixed textile resists abrasion and unintentional movement.

In some examples, the adhesive composition has an average shear strength of about 5 pounds/inch² to about 180 pounds/inch².

In some examples, the adhesive composition has an average peel strength low enough that the textile remains intact when stripped from the composition.

In some examples, the adhesive composition has an average peel strength of about 0.25 pounds/inch to about 7 pounds/inch.

In some examples, the adhesive composition has a viscosity of about 40,000 cP to about 70,000 cP.

In some examples, the textile is porous.

In one example, a method of applying a textile to an installation surface includes applying an adhesive composition to the installation surface, installing the textile on the surface, and allowing the composition to set. The textile is vinyl, scrimless, and strippable from the set composition.

In some examples, the composition is allowed to set for at least 14 days to produce a composition hard enough to sand.

In some examples, the peel strength of the composition decreases as the composition sets.

In some examples, the installation surface is primed with a primer before applying the adhesive composition.

In some examples, more than one coat of adhesive is applied to at least one corner of the installation surface.

In some examples, the adhesive composition is allowed to tack before the textile is installed.

In some examples, the seams of the textile are trimmed before installing the textile. In one example, pre-trimmed seams are mated on the installation surface.

In some examples, the seams of the textile are trimmed after installing the textile on the installation surface.

In some examples, heat is applied to remove wrinkles, creases, or bubbles in the textile.

In some examples, the installation surface is a wall.

In one example, an adhesive composition is formed of at least one dextrin and at least one polymer. The adhesive composition has an average shear strength of about 5 pounds/inch² to about 180 pounds/inch², an average peel strength of about 0.25 pounds/inch to about 7 pounds/inch, and a viscosity of about 40,000 cP to about 70,000 cP.

In some examples, the peel strength of the adhesive decreases during the setting process. In one example, the adhesive composition becomes strippable from an affixed textile covering as the peel strength decreases.

In some examples, the adhesive composition is hard enough to be sanded when it has set.

In some examples, when the adhesive composition has affixed a textile covering to a surface, the adhesive composition adheres more to the surface than to the textile.

In some examples, the weight:weight ratio of dextrin to polymer is low enough that the composition is viscous enough to remain in place when applied to a vertical surface.

In some examples, the weight:weight ratio of dextrin to polymer is from about 95 dextrin:5 polymer to about 80 dextrin:20 polymer.

In some examples, the dextrin is a partially hydrolyzed starch.

In some examples, the polymer is an acrylic polymer.

In some examples, the polymer is ethylene vinyl acetate.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments of the invention and illustrated in the accompanying drawings.

### BRIEF DESCRIPTION OF THE DRAWINGS

FIG. 1 is a perspective, cross-sectional view of an embodiment of a textile surface covering system, with a textile covering being peeled from a wall;

FIG. 2 is a flow chart illustrating a method of installing a textile surface covering; and

FIGS. 3A and 3B are enlarged views of textile surface coverings.

### DETAILED DESCRIPTION

Adhesive compositions for textile surface coverings are disclosed herein. The adhesive compositions may be used without a scrim. In the absence of a scrim, the adhesive compositions remain relatively stationary, including on a vertical surface, while they are drying or tacking. The adhesive compositions are capable of forming enough points of contact with the textile that the textile can be installed on and remain installed on a surface, including a vertical surface. The volume of adhesive composition required to install a textile on a surface is low enough that little or no adhesive bleeds through the pores of the textile. Upon removal of the covering, most or all of the adhesive composition remains adhered to the surface and little or no covering remains with the adhesive.

### Adhesive Compositions

In some embodiments, the adhesive compositions include at least one dextrin and at least one polymer. The dextrin may provide slippage to the adhesive composition and/or may make facilitate subsequent removal of a covering from an adhesive-coated surface. The dextrin may be any low-molecular weight carbohydrate produced by the partial or complete hydrolysis of a starch or glycogen. In some examples, the dextrin is a partially hydrolyzed starch.

The polymer may provide bond strength to the adhesive composition, which may help to hold a covering in place on a surface using fewer points of contact between the adhesive composition and covering than between an adhesive composition and a scrim. The polymer may also provide cohesion property to the adhesive composition, which may help components of the adhesive composition stick together.

In some embodiments, the polymer is a latex polymer. In some embodiments, the polymer is an acrylic polymer or a methacrylic polymer or a copolymer thereof. The acrylic or methacrylic polymers may be comprised of acrylate or methacrylate monomers, respectively, and derivatives thereof. Examples of acrylic and methacrylic monomers and polymers thereof include methyl acrylate, ethyl acrylate; butyl acrylate, hexyl acetate, phenyl acrylate, n-octyl acrylate, isooctyl acrylate, isononyl acrylate, isobornyl acrylate, 2-ethylhexyl acrylate, 2-hydroxy ethyl acrylate, hydroxyethyl methacrylate, 2-chloroethyl acrylate, methyl methacrylate, ethyl methacrylate, butyl methacrylate, hexyl methacrylate, phenyl methacrylate, n-octyl methacrylate, isooctyl methacrylate, isononyl methacrylate, isobornyl methacrylate, 2-ethylhexyl methacrylate, 2-hydroxyethyl methacrylate, 2-chloroethyl methacrylate, trimethylolpropane triacrylate, and acrylonitrile.

In some embodiments, the polymer is an ethylene polymer or copolymer. Examples of ethylene polymers or copolymers include ethylene acrylate, such as ethylene methacrylate, and ethylene acetate, such as ethylene-vinyl acetate.

In some embodiments, the polymer is a vinyl acetate polymer or copolymer. Examples of vinyl acetate polymers or copolymers include polyvinyl acetate (PVA), ethylene-vinyl acetate (EVA), vinyl acetate-acrylic acid (VA/AA), polyvinyl chloride acetate (PVCA), and polyvinylpyrrolidone.

Compared to other adhesives comprising dextrin and a polymer that are formulated for use with materials other than textile wall coverings, the present dextrin:polymer weight:weight ratio is lower in some embodiments. The lower weight:weight ratio, or greater proportion of polymer, may help increase viscosity of the adhesive compositions, which in turn may help the compositions stay in place on a vertical surface and not run down a vertical surface. The lower dextrin:polymer weight:weight ratio may also help prevent bleed-through of the compositions through pores in the textile wall coverings. Example weight:weight ratios of dextrin to polymer in an adhesive composition are from about 95 dextrin:5 polymer to about 80 dextrin:20 polymer, from about 90 dextrin:10 polymer to about 80 dextrin:20 polymer, from about 89 dextrin:11 polymer to about 80 dextrin:20 polymer, from about 88 dextrin:12 polymer to about 80 dextrin:20 polymer, from about 87 dextrin:13 polymer to about 80 dextrin:20 polymer, from about 95 dextrin:5 polymer to about 85 dextrin:15 polymer, from about 95 dextrin:5 polymer to about 86 dextrin:14 polymer, or from about 95 dextrin:5 polymer to about 87 dextrin:13 polymer.

In some embodiments, the adhesive compositions include one or more tackifiers. Examples of tackifiers include hydrocarbon resins, wood resins, rosin resins, rosin ester resins, polymerized rosin resins, polymerized rosin ester resins, terpene resins, terpene phenol resins, and derivatives, such as hydrogenation products, of any of the forgoing.

In some embodiments, the adhesive compositions include a thickening agent. Examples of thickening agents include silicas (silicon dioxides), silicates, and derivatives thereof, such as fumed silica, pyrogenic silica, silica gel, attapulgite, bentonites, kaolinite, montmorillonite, and talc; cellulose ethers, such as hydroxylethylcellulose; and polyvinylacetate.

The adhesive compositions may have a shear strength such that the adhesive is able to remain in place on an installation surface, such as a vertical surface, for a desired period of time. The compositions' shear strength is high enough that a textile surface covering affixed to the surface by the compositions is also held in place on the surface. The compositions' shear strength is also high enough that the affixed covering is resistant to abrasions and other physical contact such that the covering does not unintentionally peel or otherwise unintentionally move.

The adhesive compositions may have an average shear strength for example of from about 5 pounds/inch² to about 180 pounds/inch², from about 5 pounds/inch² to about 150 pounds/inch², from about 5 pounds/inch² to about 125 pounds/inch², from about 5 pounds/inch² to about 100 pounds/inch², from about 5 pounds/inch² to about 75 pounds/inch², from about 25 pounds/inch² to about 180 pounds/inch², from about 50 pounds/inch² to about 180 pounds/inch², from about 75 pounds/inch² to about 180 pounds/inch², from about 100 pounds/inch² to about 180 pounds/inch², or from about 50 pounds/inch² to about 70 pounds/inch². In one embodiment, the average shear strength is about 59 pounds/inch².

The adhesive compositions may have a peel strength on the surface coverings less than a peel strength on the surface to which the compositions are applied. The peel strength may be such that the composition usually sticks to both the surface to which it has been applied and the covering applied to the composition, but, when an attempt is made to remove the covering, the composition remains affixed to the surface instead of the covering. The adhesive compositions may have an average peel strength for example of from about 0.25 pound/inch to about 7 pounds/inch, about 0.25 pound/inch to about 6.5 pounds/inch, from about 0.25 pound/inch to about 6 pounds/inch, from about 0.25 pound/inch to about 5.5 pounds/inch, from about 0.25 pound/inch to about 5 pounds/inch, from about 0.25 pound/inch to about 4.5 pounds/inch, from about 0.25 pound/inch to about 4 pounds/inch, from about 0.25 pound/inch to about 3.5 pounds/inch, from about 0.25 pound/inch to about 3 pounds/inch, from about 0.25 pound/inch to about 2.5 pounds/inch, from about 0.5 pound/inch to about 6.5 pounds/inch, from about 1 pound/inch to about 6.5 pounds/inch, from about 1.5 pounds/inch to about 6.5 pounds/inch, from about 2 pounds/inch to about 6.5 pounds/inch, or from about 2 pounds/inch to about 2.5 pounds/inch. In one embodiment, the average peel strength is about 2.2 pounds/inch.

The relative performance characteristics of the adhesive compositions may help produce compositions that remain in place on a surface while an affixed textile covering is removed, largely intact, from the surface. For example, the adhesive compositions may have a higher adhesion to a surface or to a primer-coated surface than to a covering. The peel strength of the compositions may be low enough that the covering does not break or tear when the covering is removed from the surface. For example, the peel strength of the compositions may be lower than the tear strength of the covering such that the compositions detach from the covering without the covering tearing. As another example, the peel strength of the composition may be lower than its shear strength such that the compositions detach from the covering before the covering tears or breaks.

As another example, the peel strength may be low enough that the compositions remain affixed to a surface while the shear strength may be high enough that the compositions are resilient on the surface.

The peel strength of the presently disclosed adhesive compositions to the coverings may be lower than the peel strength of known adhesive compositions to scrims. Compared to known adhesive compositions used with scrims, the presently disclosed adhesive composition and only the composition remains on the surface when the covering is removed.

The adhesive compositions may have a viscosity low enough that the composition is spreadable on an installation surface, but high enough that when it is applied to a vertical wall it does not migrate down the wall. The viscosity may also be low enough in relation to the size of the pores in the wall covering textile that the composition can enter the pores of the textile, but high enough that the composition does not bleed through to the front surface of the textile. The adhesive compositions may have a viscosity, for example, of about 40,000 cP to about 70,000 cP or about 50,000 cP to about 60,000 cP at 20° C.

Under some environmental conditions, the adhesive compositions are capable of setting such that they become mostly or completely hard. In some embodiments, the compositions set such that little or no rubberiness or gumminess remains. Increasing hardness helps make the compositions easier to sand off the surfaces to which they have been applied.

Under some environmental conditions, the adhesive compositions are capable of setting such that little or no residual tackiness remains. Minimizing residual tackiness helps to prevent dust or other particles from adhering to adhesive compositions accessible through the pores of the textile.

Under some environmental conditions, the adhesive compositions may set mostly or completely over time. Setting mostly or completely helps make the compositions adhere to the surface to which they have been applied while also being strippable or releasable from the textile covering adhered to the compositions. Setting to a lesser extent may prevent the compositions from being strippable from the coverings. In some embodiments, the peel strength of the adhesive decreases during the setting process. In some embodiments, the peel strength starts high enough that the adhesive compositions are not strippable from the coverings or are poorly strippable and the peel strength decreases during the setting process such that the compositions become strippable. In some embodiments, the adhesive compositions set completely in about 14 days to about 21 days.

The adhesive compositions disclosed herein may be applied to installation surfaces. An installation surface may be a vertical surface, such as a wall, or horizontal surface, such as a floor. Suitable substrates are relatively hard and include, but are not limited to, gypsum, wood, plastic, and PVC. In some embodiments, the substrate is primed, such as with a latex primer, before application of the adhesive composition.

### Systems

Systems for covering installation surfaces may include any adhesive composition described above and a textile surface covering. The textile surface coverings may be constructed of a vinyl material. The vinyl material may be non-porous. In some embodiments, the surface coverings also include a plasticizer. The plasticizer may help impart pliability to vinyl surface coverings. The plasticizer may be bio-based or synthetic. A bio-plasticizer may remain within a vinyl surface covering better than a synthetic plasticizer. In some embodiments, the plasticizer is a bio-plasticizer derived from soybeans, such as epoxidized soybean oil. One example of a suitable bio-plasticizer is Terrastrand®.

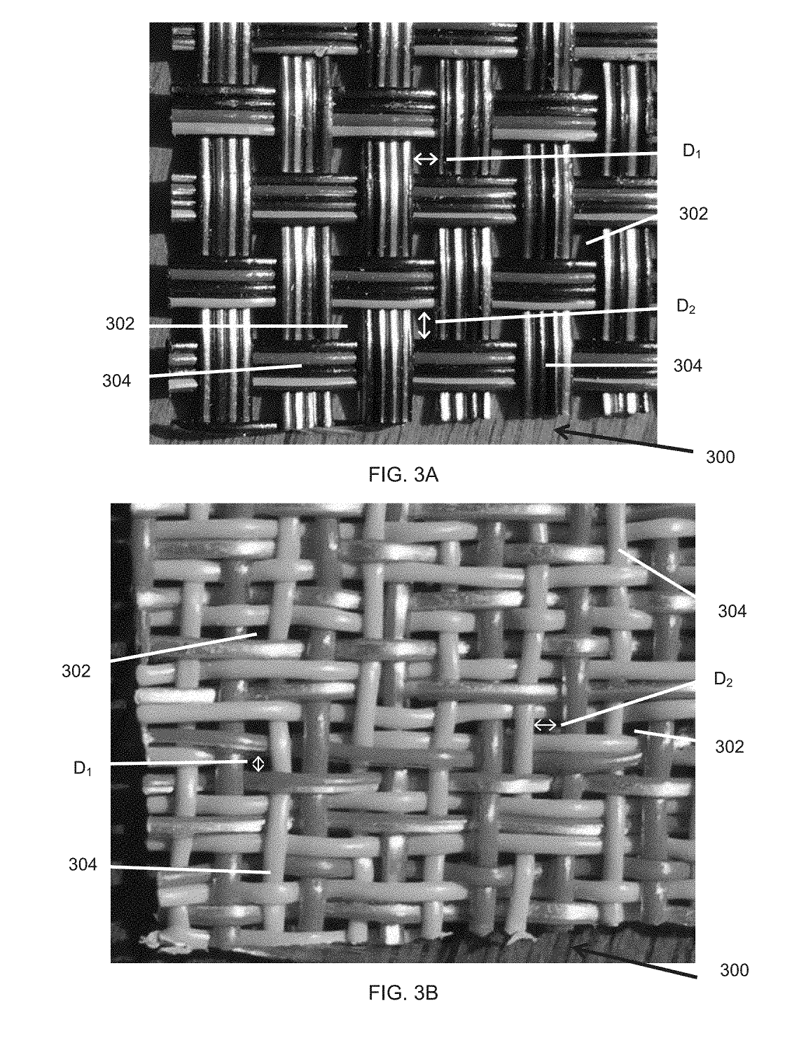

With reference to FIGS. 3A and 3B, the surface coverings 300 may include a plurality of pores 302 formed between approximately perpendicularly arranged strands or fibers 304, such as in a woven fabric. Each pore may have a minimum dimension (D₁) as measured across the shortest dimension (e.g., length, width, or diameter) and a maximum dimension (D₂) as measured across the longest dimension (e.g., length, width, or diameter).

The pore size minimum dimension D₁ may range from about 0.01 mm to about 2 mm, from about 0.01 mm to about 1.5 mm, from about 0.01 mm to about 1 mm, from about 0.01 mm to about 0.5 mm, from about 0.1 mm to about 2 mm, from about 0.5 mm to about 2 mm, or from about 1 mm to about 2 mm. In one example, D₁ is about 0.05 mm.

The pore size maximum dimension D₂ may range from about 0.1 mm to about 4 mm, from about 0.1 mm to about 3.5 mm, from about 0.1 mm to about 3 mm, from about 0.1 mm to about 2.5 mm, from about 0.1 mm to about 2 mm, from about 0.1 mm to about 1.5 mm, from about 0.1 mm to about 1 mm, from about 0.5 mm to about 4 mm, from about 1 mm to about 4 mm, from about 1.5 mm to about 4 mm, from about 2 mm to about 4 mm, from about 2.5 mm to about 4 mm, or from about 3 mm to about 4 mm. In one example, D₂ is about 3 mm.

In a square inch of surface covering, pores may make up about 5% to about 35% of the area, about 5% to about 30%, about 5% to about 25%, about 5% to about 20%, about 5% to about 15%, about 5% to about 10%, about 10% to about 35%, about 15% to about 35%, about 20% to about 35%, about 25% to about 35%, about 30% to about 35%, or about 8% to about 29%. In one example, pores make up about 17% of the surface area of the coverings.

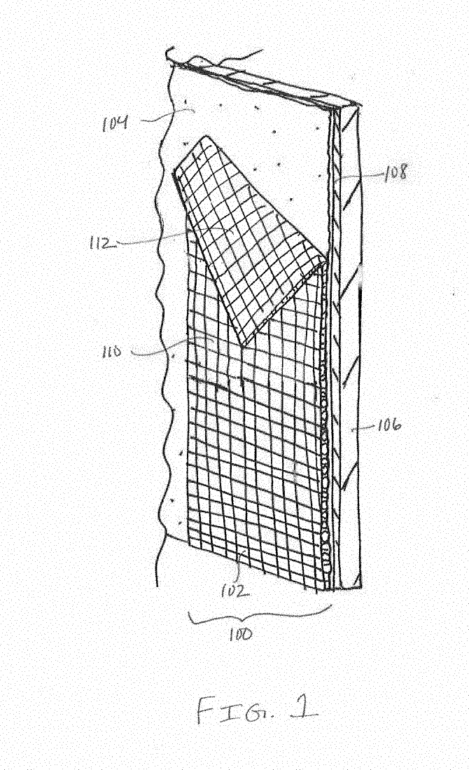

With reference to FIG. 1 (described in more detail below), either or both of a first surface 110 and a second surface 112 of the textile covering 102 may be non-planar. For example, when the textile covering 102 is constructed of a woven, loosely knit, or similar material, the fibers may yield a textile covering 102 with an uneven surface or surfaces 110, 112. In some embodiments, an uneven surface 110, 112 reduces the potential number of contact points between the covering 102 and an adhesive composition 104 as compared to a covering with an even or planar surface. In some embodiments, applying a textile covering 102 with an uneven surface 110, 112 to a surface without using a scrim reduces the potential number of contact points between the covering 102 and an adhesive composition 104 as compared to using a scrim.

With continued reference to FIG. 1, the percentage of the area of the second surface 112 in contact with the adhesive composition 104 when the textile covering 102 is applied to an installation surface 106 may range from about 2% to about 20%, from about 2% to about 18%, from about 2% to about 16%, from about 2% to about 14%, from about 2% to about 12%, from about 2% to about 10%, from about 2% to about 8%, from about 4% to about 20%, from about 6% to about 20%, from about 8% to about 20%, from about 10% to about 20%, from about 12% to about 20%, from about 14% to about 20%, from about 16% to about 20%, or from about 4% to about 16%.

The surface coverings may have a tensile strength high enough that the covering can be peeled off the surface to which it has been applied with no or minimal breaking or tearing. Surface coverings that remain intact while being removed from an installation surface are easier and faster to remove than those that separate into pieces.

One example of a suitable textile surface covering is a Plynyl® porous vinyl surface covering (Chilewich Sultan LLC, New York, N.Y.).

The composition of the adhesive is preferably selected so that the fabric adhered to a wall is strippable (removable) at any time following installation and setting while leaving little or no textile residue on the surface. The system may be strippable such that minimal prep work is required before the next surface treatment is applied. The prep work may include, for example, sanding the adhesive off the surface and/or priming the surface.

FIG. 1 depicts one example of a surface-covering system, in which the textile covering is being peeled from a wall. The system 100 shown includes a textile covering 102 and an adhesive composition 104. The covering 102 and composition 104 is applied to a surface 106. In the embodiments shown, the surface 106 is a vertical wall, and the surface 106 is coated with a primer 108. In other embodiments, the adhesive can be applied directly to a dull or non-glossy wall without a primer. In FIG. 1, the textile covering 102 is shown partially being peeled off the surface 106 and from the adhesive, such as by pulling on a free corner or the free side of the covering 102, leaving the adhesive composition 104 and primer 108 still affixed to the surface 106.

### Methods

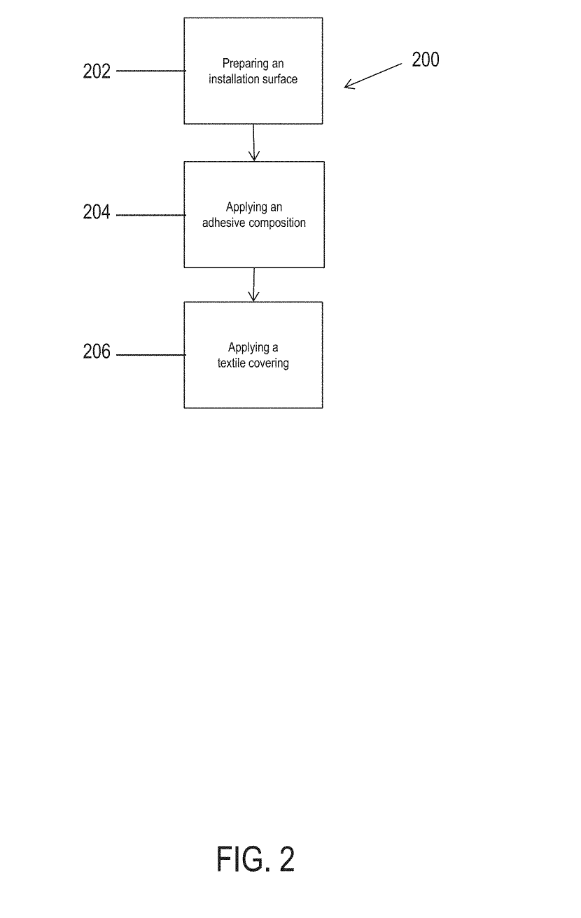

FIG. 2 depicts a method of installing a textile surface covering. The method 200 may include a step 202 of preparing an installation surface, which step 202 may include removing any previously installed covering or adhesive composition, cleaning the surface, and/or applying a primer. When the surface is ready, a step 204 of applying an adhesive composition to the prepared surface is performed. The composition may be applied by rollers or brushes. The method 200 also includes a step 206 of applying a textile covering to the adhesive composition that has already been applied to the surface. Step 206 may include trimming excess covering material, wrapping the covering around edges, and smoothing wrinkles.

### EXAMPLES

Some examples illustrating various aspects of the disclosure follow below. Other examples may be implemented.

### Example 1—Abrasion Test of Textiles

Two woven vinyl textile samples were prepared by adhering each sample to a ¾-inch-thick gypsum board using an adhesive composition disclosed herein. The textiles were placed such that a seam of each sample ran the entire length of the board. A rubbing action was applied to the exposed face of each sample. The rubbing action was created by a neolite heel fixture loaded to 1 kilogram per inch and was applied for 200 cycles. The rubbing was applied both on the sample seam and across the seam.

Following the tests, close visual examination of the adhesion revealed no release or delamination. No effect on the seam integrity was observed following rubbing either with or across the seam.

The results demonstrate that textile samples applied with an adhesive composition and without a scrim are durable and have high shear strength.

### Example 2—Application of Textiles to Installation Surfaces

Plynyl® textile products (Chilewich Sultan LLC, New York, N.Y.) were applied to vertical and horizontal installation surfaces according to the following procedure.

The textile products and adhesive composition were acclimated for 48 hours at 68-75° F. (20-24° C.). The textile products were unrolled face out 24 hours prior to installation to allow wrinkles and creases to relax and smooth. Indirect heat from a heat gun held 3-4 inches from the textiles was also used to remove wrinkles or creases.

Installation surfaces were prepared by removing any previously installed covering or adhesive composition. Newly plastered walls were allowed to dry. All surfaces were clean, free of dust and contaminants, and primed with a latex primer, including pigmented latex primers. Glossy surfaces were sanded until dull. The outside corners (1 foot on each side) of the installation surfaces were pre-pasted with adhesive composition applied with a ½-inch nap roller. The adhesive composition was allowed to dry. Pre-pasting may help give the adhesive composition more volume to embed the fabric to create a tight corner with the stiff textiles.

The adhesive composition was whipped with a paint mixer or mixed with a paint shaker, which may help achieve uniform application of the adhesive composition. The adhesive composition was evenly and thoroughly applied to the installation surfaces, not to the textiles, with a ½-inch nap roller cut in with a paint brush. The adhesive composition was allowed to tack, but was not dry to the touch, before the textiles were installed.

The seam edges of the textiles were trimmed with a razor blade to remove 2-3 inches, which may help achieve seam uniformity. When installed on vertical surfaces, the first drop was hung to a plumb line and was allowed to overlap onto the ceiling and baseboards. Some drops were tacked with push pins at the top to help hold the textile product in place. Air bubbles were removed, and good contact between textile and installation surface was ensured, using a smoothing brush, broad knife, or plastic smoother.

Excess textile at the ceiling, baseboards, windows, etc. was trimmed with a razor blade or scissors. Sometimes seams were straight-edged before installation and sometimes two drops were overlapped and double-cut without scoring the underlying installation surface. Trimming and seam closure was performed within one hour. Seams that did not adhere well were temporarily held open with push pins while additional adhesive was applied with a paint brush to the installation surface underneath the seam area.

A seam roller was used to flatten the textile edges at seams, ceilings, baseboards, etc. Tightly bonded corners were formed by applying heat indirectly from a heat gun while pushing bubbles or wrinkles around the corners and bending the textile to create a smooth, tight appearance.

Each installed strip was sponged with clean water to remove any excess adhesive and then blotted with a dry towel. If necessary, areas were cleaned a second time and a soft bristle brush was used to remove stubborn adhesive.

Although various embodiments have been described above with a certain degree of particularity, or with reference to one or more individual embodiments, those skilled in the art could make numerous alterations to the disclosed embodiments without departing from the spirit or scope of this disclosure. Other embodiments are therefore contemplated. All matter contained in the above description is illustrative only of particular embodiments and is not limiting. Changes in detail or structure can be made without departing from the basic elements described herein.

What is claimed is:

1. A system for covering an installation surface, comprising:
a vinyl, scrimless textile; and
a settable adhesive composition;
wherein when the adhesive composition has set, the composition is hard enough to sand, the composition adheres less to the textile than to the installation surface, and the textile is strippable from the composition.

2. The system of claim 1, wherein the adhesive composition remains affixed to the surface but not to the covering when the covering is removed from the surface.

3. The system of claim 1, wherein the adhesive composition has an average shear strength high enough that the affixed textile is held in place on the surface.

4. The system of claim 1, wherein the adhesive composition has an average shear strength high enough that the affixed textile resists abrasion and unintentional movement.

5. The system of claim 1, wherein the adhesive composition has an average shear strength of about 5 pounds/inch² to about 180 pounds/inch².

6. The system of claim 1, wherein the adhesive composition has an average peel strength low enough that the textile remains intact when stripped from the composition.

7. The system of claim 1, wherein the adhesive composition has an average peel strength of about 0.25 pounds/inch to about 7 pounds/inch.

8. The system of claim 1, wherein the adhesive composition has a viscosity of about 40,000 cP to about 70,000 cP.

9. The system of claim 1, wherein the textile is porous.

10. A method for applying a textile to an installation surface, comprising:
applying an adhesive composition to the installation surface,
installing the textile on the surface, and
allowing the composition to set,
wherein the textile is vinyl, scrimless, and strippable from the set composition.

11. The method of claim 10, wherein the composition is allowed to set for at least 14 days to produce a composition hard enough to sand.

12. The method of claim 10, wherein the peel strength of the composition decreases as the composition sets.

13. The method of claim 10, comprising priming the installation surface with a primer before applying the adhesive composition.

14. The method of claim 10, comprising applying more than one coat of adhesive to at least one corner of the installation surface.

15. The method of claim 10, comprising allowing the adhesive composition to tack before installing the textile.

16. The method of claim 10, comprising applying heat to remove wrinkles, creases, or bubbles in the textile.

17. The method of claim 10, wherein the installation surface is a wall.

18. An adhesive composition, comprising:
at least one dextrin; and
at least one polymer;
wherein the adhesive composition has an average shear strength of about 5 pounds/inch² to about 180 pounds/inch²,
the adhesive composition has an average peel strength of about 0.25 pounds/inch to about 7 pounds/inch, and
the adhesive composition has a viscosity of about 40,000 cP to about 70,000 cP.

19. The adhesive composition of claim 18, wherein the peel strength of the adhesive decreases during the setting process.

20. The adhesive composition of claim 18, wherein the adhesive composition is hard enough to be sanded when it has set.

21. The adhesive composition of claim 18, wherein when the adhesive composition has affixed a textile covering to a surface, the adhesive composition adheres more to the surface than to the textile.

22. The adhesive composition of claim 18, wherein the weight:weight ratio of dextrin to polymer is from about 95 dextrin:5 polymer to about 80 dextrin:20 polymer.
